(19) United States
(12) Patent Application Publication
(10) Pub. No.: US 2019/0146447 A1
(43) Pub. Date: May 16, 2019

(54) METHOD FOR MAINTAINING AT LEAST ONE FIELD DEVICE OF PROCESS AUTOMATION TECHNOLOGY

(71) Applicant: Endress+Hauser Conducta GmbH+Co. KG, Gerlingen (DE)

(72) Inventors: Joachim Albert, Leonberg (DE); Stefan Robl, Hünxe (DE)

(21) Appl. No.: 16/163,890

(22) Filed: Oct. 18, 2018

(30) Foreign Application Priority Data
Nov. 16, 2017 (DE) 10 2017 127 024.8

(51) Int. Cl. G05B 19/042; G05B 19/418; G05B 23/02

(52) U.S. Cl. CPC G05B 19/0428; G05B 19/4185; G05B 2219/25428; G05B 23/0272; G05B 23/024

(57) ABSTRACT

The present disclosure discloses a method for maintaining at least one field device of process automation technology, comprising the steps of connecting a smart device to the field device via a data connection and maintaining the field device via the smart device.

### CROSS-REFERENCE TO RELATED APPLICATION

The present application is related to and claims the priority benefit of German Patent Application No. 10 2017 127 024.8, filed on Nov. 16, 2017, the entire contents of which are incorporated herein by reference.

### TECHNICAL FIELD

The present disclosure relates to a method for maintaining at least one field device of process automation technology.

### BACKGROUND

Field devices serving to capture and/or modify process variables are frequently used in process automation technology. Field devices, in general, refer to all devices which are process-oriented and which supply or process process-relevant information. Sensors, in particular, are to be mentioned here, but also actuators. Field devices designed as sensors can, for example, monitor process measurands, such as pressure, temperature, flow, and fill-level, or measurands in liquid and/or gas analysis, such as pH, conductivity, concentrations of certain ions, chemical compounds, and/or concentrations or partial pressures of gas.

Generally speaking, a measuring transducer—also called a transmitter—is a device that converts an input variable into an output variable according to a fixed relationship. In process automation technology, a sensor is connected to a measuring transducer. The raw measured values of the sensor are processed in the measuring transducer, e.g., averaged or converted by means of a calibration model to another variable—for example, the process variable to be determined—and possibly transmitted—to a control system, for example. Generally, a cable for connection to the sensor is connected to the measuring transducer. The measuring transducer is in this case a separate device with a separate housing and various interfaces. Alternatively, the measuring transducer can be integrated, e.g., in the form of a circuit—possibly as a microcontroller or something similar—into a cable or directly into a plug connection. A measuring transducer is also a field device within the meaning of this application.

The Endress+Hauser Group makes and distributes a large variety of such field devices.

For parameterizing, testing, and troubleshooting field devices, various other operating options are available to a user—in addition to the possibly existing operation on a display integrated into the field device. To be mentioned in this respect, on the one hand, is operation via a device driver (DTM), which is coupled to the field device by means of a fieldbus or a field device interface. On the other hand, there is the possibility of operating the field device by means of a web server from a location remote from the field device. Lastly, the possibility of operation by means of a smartphone and an appropriate app via a radio connection to the field device also exists.

When using this respective app, one is reliant upon the use of smartphones or tablets. With these device types, several disadvantages arise during practical application in the field. For example, the user thus has only one hand free for work to be done; the other hand is needed for operating the smartphone. In this case, a safe location for laying down the smartphone is frequently not available, which results in the risk of damage to or destruction of the smartphone or of the user falling. When it rains, the smartphone is difficult to operate. Notifications on the smartphone are only noticed to a limited degree. Smartphones must generally be deliberately taken into one's hand in order to be able to interact with the field devices.

### SUMMARY

The present disclosure is based upon the aim of simplifying the operation of field devices.

The aim is achieved by a method comprising the steps of connecting a smart device to the field device via a data connection and maintaining the field device via the smart device.

In one embodiment, the smart device is connected to a switching system or a cloud infrastructure, via which the data connection is relayed to the field device. The connection thus takes place from the field device, via the cloud infrastructure or the switching system, to the smart device.

Alternatively or additionally, the data connection is designed as a wireless connection. In one embodiment, a wireless connection is a Bluetooth connection, WLAN (standard or IEEE-802.11 family), or mobile radio according to one of the standards, 2G, 3G, LTE, LTE-Advanced, 5G, or something similar. The connection thus takes place from the field device directly to the smart device.

“Maintaining” field devices within the meaning of this application is to be understood as operating the field device and/or as supporting and carrying out service measures by the user. A service measure is in this case, for example, an adjustment, calibration, cleaning, parameterization, or diagnosis.

If a user is in the vicinity of a field device for which a service measure is due soon, the smart device can trigger a message (see below) so that the user can carry out the measure immediately, if possible, in order to save additional travel.

Via a central data repository, the switching system, or the cloud infrastructure, this list can also be synchronized with several users, so that the service measures can be processed by the “next best” employee.

In one embodiment, the smart device is connected to a smartphone, tablet, or phablet, wherein the smartphone, tablet, or phablet is connected to the field device. The smartphone, tablet, or phablet thus acts as a bridge for the smart device. In one embodiment, connecting the smart device to the field device without an additional bridge is possible.

Smart devices are generally electronic devices that are wireless, mobile, networked, and equipped with various sensors (e.g., geosensors, gyroscopes, temperature sensors, or even with a camera).

In one embodiment, the smart device is a smartwatch.

In one embodiment, the smart device is an activity tracker, fitness tracker, or article of clothing into which electronic means for communication, display, or reproduction are integrated.

In one embodiment, the smart device is a miniature computer worn on the head, with an optical display that is mounted on eyeglass frames in the periphery of the field of vision.

In one embodiment, the smart device is integrated into safety glasses.

In one embodiment, insets regarding the field device are shown via the display.

In one embodiment, the smart device is designed as augmented-reality glasses.

The user receives each message or notification (see below) visually and, optionally, acoustically. As a result of the possibility of overlaying real images and computer images, a noticeable inset can also be used by means of augmented-reality glasses. For example, a blinking red frame around a field device that has a problem can be realized in this way. In this way, associating an error message with a real device is significantly simplified. As a result of the aforementioned image overlay, when viewing a field device, its status and measured values can be displayed as “floating” over the device. In this way, a field device without a physical device display obtains a virtual equivalent, so to speak.

In the embodiment as augmented-reality glasses, an overview image is realized, which the field devices (in one embodiment, sorted by distance) with device tag, serial number, name, condition, and/or measured values, etc. In this way, the condition of many devices that are in the vicinity of the user can be read directly and immediately with a single glance at the smartwatch/through the glasses, for example. An overview of the condition of surrounding devices is quickly possible as a result.

In one embodiment, messages are acknowledged by the user via gestures or voice control.

Acknowledgment of a message or selection in the menu can take place verbally by means of speech recognition or via gesture control. Via virtual input fields, buttons, and controls, the parameters of a field device can be changed directly.

In one embodiment, the smart device comprises at least one camera, and the images of the camera are provided to a remotely located service technician for remote maintenance. In case of problems, the user can make contact with an—external—service technician, who can not only communicate with the user, but can also take over the operation of the devices, if need be. In doing so, the service technician can also access the camera pictures of the glasses and instruct the user in the necessary hand movements.

By realizing a device menu optimized for the smart device, it can be avoided that a user has to take an additional device into his hand when working with the field device: a smartwatch, for example, is located safely on the wrist; glasses are located safely on the head of the user. Via the device menus which become possible as a result, the most important operating steps for maintaining and repairing a field device can be displayed. Via the signaling options of smart devices (vibration, optical signal, acoustic signal, voice announcement), the user can, for example, be advised of the conclusion of an operating step that takes a longer period of time (e.g., waiting for stability criteria during the adjustment/calibration). Simple operating steps (adjustment of individual values) can be carried out directly via the smart device via the optimized device menu, so that taking out a smartphone/tablet/phablet can be avoided.

In one embodiment, the smart device outputs a message when a service measure is due for the field device. A vibration of the smart device, sounds from the smart device, or a special view on or from the smart device, for example, is in this case to be meant as a message.

By using different vibration patterns, several things can be signaled, without the necessity of a glance at the smart device. If, in the vicinity, one or more devices were newly discovered, they are in OK condition; and/or, in the vicinity, there is at least one device that is no longer in OK condition; and/or, in the vicinity, there is one device that requires a service measure soon. By means of this signaling variant, a user can decide whether interruption of the current activity is reasonable or necessary, even if glancing at the smart device directly is not possible at the moment.

Via a message or notification, a smart device can discreetly and nonetheless clearly advise of such events without a separate device (e.g., a smartphone) having to be taken into one's hand. As mentioned, vibration systems additionally integrated into the smart device allow a type of communication that does not require any visual contact. This can achieve the following: Signaling the user that a field device located in the vicinity is in a condition that requires an action of the user. As a result, a field device can directly make itself noticeable to the user, even in confusing environmental situations. Signaling the user that a known field device is in the vicinity. The signaling information can include the device name, the device condition, and the current measured values. In this way, the main properties of a field device can already be read without any user interactions solely by approaching the field device. Signaling the user that a cyclic service check of a device in the vicinity is due in the near future and that this check could practically be carried out immediately as a result of the physical proximity of the user.

In one embodiment, these notifications are equipped with several directly operable options that can be selected by the user. Examples in this respect are: “Remind me later”, “Open device menu”, “Device OK”, “Report device”, etc.

If the user selects “Open device menu”, an operating menu suitable for this application opens on the smart device, and the user can operate the device via this menu (e.g., in order to diagnose, parameterize, adjust, or calibrate it).

If “Device OK” is selected, the user confirms that he found the status of the device and the measured value to be good and has performed a visual check of the measuring point. This option is, in particular, practicable for periodic service checks.

If “Report device” is selected, the respective device is included in a watch list, to plan more comprehensive measures (e.g., device replacement).

In one embodiment, the upcoming and completed service measures are synchronized with a switching system, such as a central server, or a cloud infrastructure. These service measures can thus be divided between several service technicians. In this way, it is possible to increase the efficiency of the service personnel, since it can thus be effectively avoided that two service technicians, for example, unknowingly complete the same service measure on the same field device shortly after one another.

In one embodiment, operating steps of a service measure of the field device are displayed in a smart device. The user is thereby guided step-by-step through the service measure.

In one embodiment, the smart device outputs a list of field devices that can be connected in the vicinity, e.g., within the range of the wireless connection.

In one embodiment, the smart device, smartphone, tablet, or phablet comprises a module for position determination, and the smart device outputs a message when a field device within range of the wireless connection does not establish a connection to the smart device.

By means of the position determination, the following is achieved in one embodiment: If, according to his position, a user is within radio range of a field device, but the field device unexpectedly does not appear in radio range, the user can be informed about a possibly failing device. This supplements the option that the smart device trigger certain suggestions based upon the proximity to a field device (e.g., maintenance measure due soon), since the proximity to an unexpectedly no longer reachable device can also be detected in this case. The suggestion can also be triggered via the smartphone, phablet, or tablet.

In one embodiment, the smart device outputs a message when a field device located in the vicinity requires an action of the user. Such a message can then be an error message, for example, or a request to perform a service measure. The distance to the field device can in this case be determined via a position determination—e.g., via GPS—or via the existence of the radio transmission of the field device.

In one embodiment, a user must confirm the message, and an operating menu relating to the required action is opened in or by means of the smart device.

In one embodiment, the smart device displays the main properties of the field device after connecting thereto.

### BRIEF DESCRIPTION OF THE DRAWINGS

This will be explained in more detail with reference to the following figures. Shown are:

FIGS. 1A-1D show field device and smart device,

FIG. 2 shows a screenshot of a smart device of a list of devices,

FIG. 3 shows a screenshot of a smart device of an overview of a field device,

FIGS. 4A and 4B show screenshots of a smart device in case of error, and

FIG. 5 shows a smart device during an adjustment.

### DETAILED DESCRIPTION

In the figures, the same features are identified with the same reference symbols.

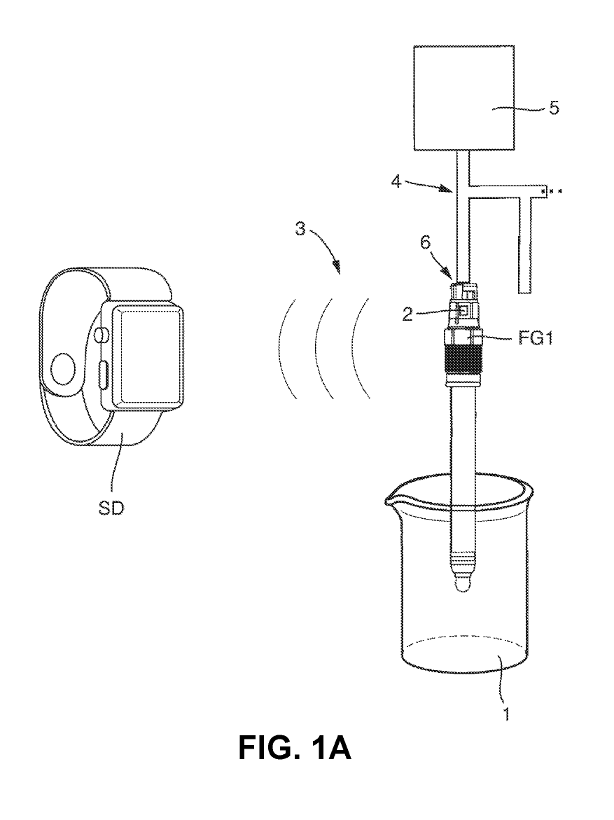

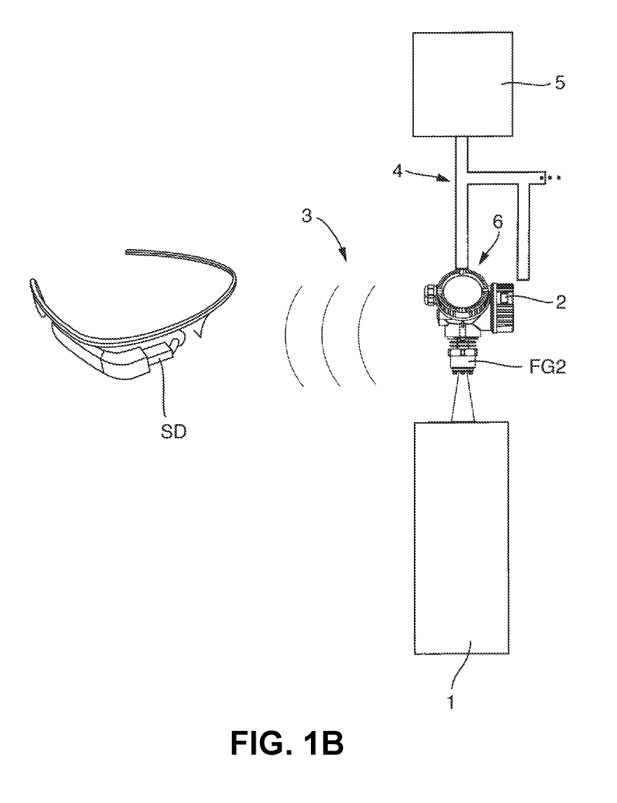

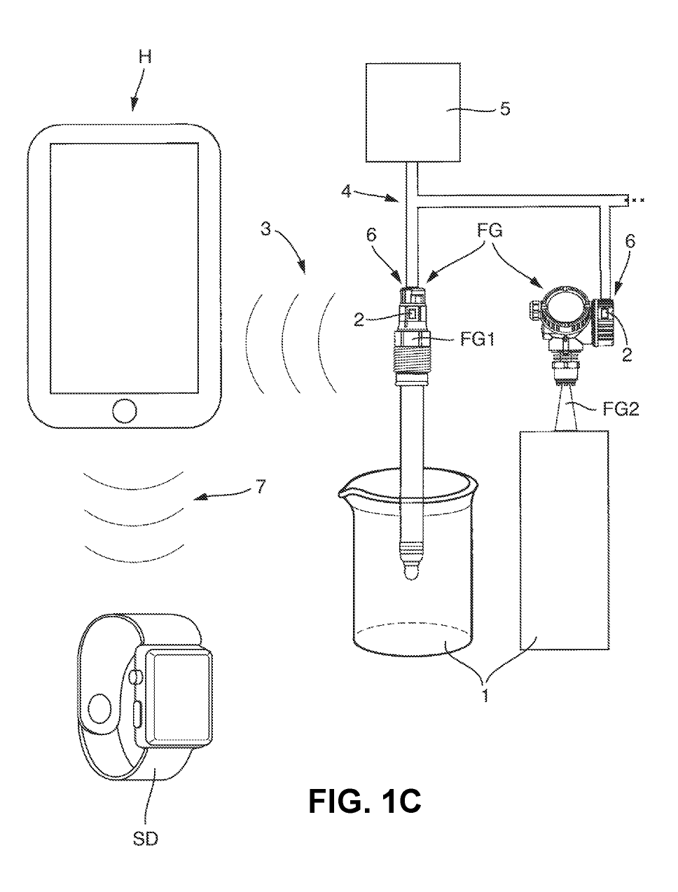

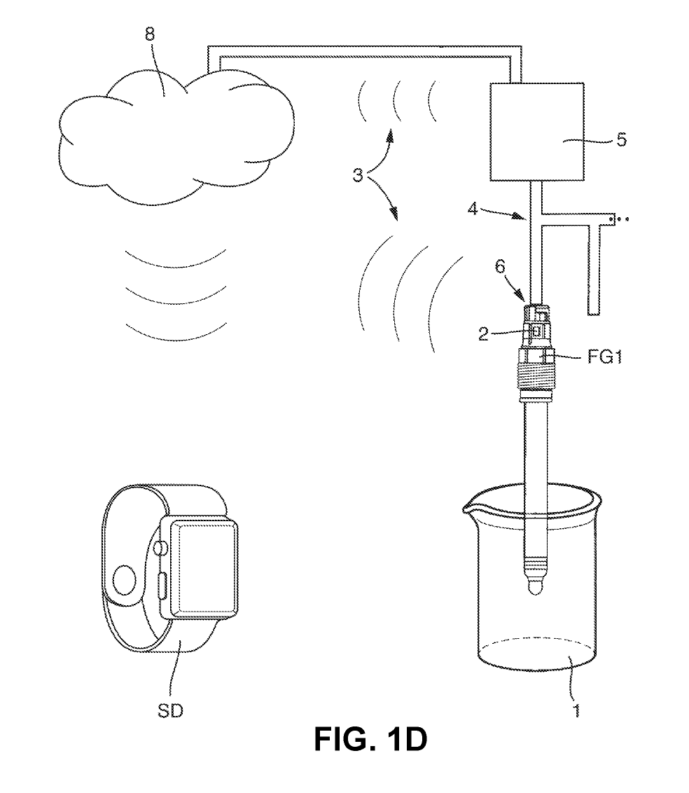

FIGS. 1A-1D show field devices FG of process automation technology, e.g., a sensor. In particular, two field devices FG1 and FG2 are shown. The sensor is, for example, a pH, redox potential, or ISFET, ion-selective, turbidity, or oxygen sensor. Other possible sensors are temperature sensors or flow sensors according to the principles of Coriolis, magnetic induction, vortex, and ultrasound. Further possible sensors are sensors for measuring the fill-level according to the principles of guided and freely-radiating radar, as well as ultrasound, also for detection of limit level, wherein capacitive methods can also be used to detect the limit level.

FIG. 1A and FIG. 1D show a pH sensor, and FIG. 1B shows a fill-level sensor according to the radar principle. In FIG. 1C, a pH sensor is shown on the left side, and a fill-level sensor according to the radar principle is shown on the right side. The field device FG determines a measurand of a medium 1—in the example, in a beaker, as shown in FIGS. 1A-1D or on the left side in FIG. 1C. Other containers, such as lines, reservoirs (as shown in FIG. 1B or on the right side in FIG. 1C), tanks, vessels, pipes, pipelines, or the like, are also possible.

The field device FG communicates with a control unit, e.g., directly with a control system 5 or with an interconnected transmitter. The transmitter can also be part of the field device, e.g., in the case of the fill-level sensor. The communication to the control system 5 takes place via a bus 4, e.g., via a two-wire bus, such as HART, PROFIBUS PA, or FOUNDATION Fieldbus. Additionally or alternatively, it is also possible to design the interface 6 to the bus as a wireless interface, e.g., according to the WirelessHART standard (not shown), wherein a direct connection to a control system via a gateway is established via WirelessHART. In addition, a 4 . . . 20 mA interface (not shown) is provided, optionally or additionally, in the case of the HART protocol. If, instead of directly to the control system 5, the communication is, additionally or alternatively, carried out to a transmitter, either the aforementioned bus systems (HART, PROFIBUS PA, or FOUNDATION Fieldbus) can be used for communication, or, for example, a proprietary protocol, e.g., of the “Memosens” type, is used. The respective field devices as described above are marketed by the applicant.

As mentioned, at the bus-side end of the field device FG, an interface 6 is provided for the connection to the bus 4. Shown is a wired variant for connection to the bus by means of the interface 6. The interface 6 is, for example, designed as a galvanically-isolating interface—especially, as an inductive interface. This is shown in a pH sensor. The interface 6 then consists of two parts, with a first part on the field device side and a second part on the bus side. They can be joined via a mechanical plug connection. Data (bi-directionally) and energy (uni-directionally, i.e., in the direction from the control unit 5 to the field device FG), are transmitted via the interface 6. Alternatively, an appropriate cable, with or without galvanic isolation, is used. Possible embodiments include a cable with an M12 or ⅞″ plug. This is, for example, shown in a fill-level measuring device according to the radar principle.

The field device FG comprises a wireless module 2 for wireless communication 3. This wireless communication 3 does not serve the connection to the bus 4.

The wireless module 2 is designed as a Bluetooth module, for example. The Bluetooth module satisfies, in particular, the low energy protocol stack as “Bluetooth Low Energy” (also known as BTLE, BLE, or Bluetooth Smart). Where appropriate, the wireless module 2 comprises an appropriate circuit or components. The field device FG therefore at least satisfies the “Bluetooth 4.0” standard. The communication 3 takes place from the field device FG to a smart device SD. The smart device SD is, for example, a smartwatch (FIGS. 1A and 1D, FIG. 1C) or glasses, the inner surfaces of which serve as a display screen (FIG. 1B). The smart device of FIG. 1B is thus a miniature computer worn on the head, with an optical display that is mounted on eyeglass frames in the periphery of the field of vision. These glasses can also be designed as safety glasses.

A data connection is, in general, established between the field device FG and the smart device SD. In one embodiment, this is a direct wireless connection; see, for example, FIG. 1A or FIG. 1B.

In FIG. 1A and FIG. 1B, the field device FG communicates directly with the smart device SD. In FIG. 1C, the field device FG communicates via a mobile device M with the smart device SD via the wireless connection 7. The mobile device M is a smartphone, tablet, or phablet. The wireless connections 3, 7 are of the same type; in this case, they are thus designed as Bluetooth connections, as described above. They can, however, deviate from one another. The wireless connections 3, 7 can basically be designed as a Bluetooth connection or WLAN (standard of the IEEE-802.11 family). The field device FG, mobile device M, and smart device SD respectively comprise the appropriate interfaces for the wireless communication 3, 7.

If a user A with a smart device SD is within range of a field device FG, a connection 3 is established. The field devices FG are in broadcast mode.

FIG. 1D shows an embodiment as an alternative or in addition to a direct data connection between the smart device SD and the field device FG. In this case, the field device FG has a data interface that is first connected to a superordinate switching system 8. The switching system 8 can in this case take shape as a server system installed at the user's, as well as in the form of an internet-based cloud infrastructure. The smart device SD does not connect in this case directly to the field device FG; rather, the field device FG or the smart device SD establishes the data connection 3 via a communication network available at the user's, e.g., WLAN (standard of the IEEE-802.11 family) or a mobile radio standard, such as GSM—in particular, UMTS or 5G. The connection can also be carried out from the field device via the bus 4 via the control system 5 to the switching system 8. This connection from the control system 5 takes place in a wireless or wired manner.

Via the switching system 8 or the cloud, the data connection to the respective field device FG is then relayed. In this case, an additional communications system (such as the previously described wireless module 2), for the field device FG, is no longer required.

In the case of field devices FG that have an Ethernet-based communication interface and are connected to the control system 5 via the field bus protocols PROFINET, Ethernet/IP, ModbusTCP, or OPC UA, an additional communication connection, e.g., via the HTTPS protocol, can be realized via the same communication interface to the described switching system or to a cloud infrastructure, whereby the smart device SD can obtain access to the field device FG.

The described switching system 8 can even be integrated into the field device FG itself. In this case, the smart device SD establishes a connection to the local network (LAN) via an existing local WLAN infrastructure, for example. In the LAN, the field device FG can be reached via its communication interface—in particular, an Ethernet interface. If LAN and WLAN are connected to each other, the smart device SD can also in this case communicate with the field device FG without an additional communication system (as the previously described wireless module 2) and, in this case, does not depend upon a separate switching system 8 or a cloud infrastructure.

The smart device SD supports the user in a service measure, such as an adjustment, calibration, cleaning, parameterization, or diagnosis.

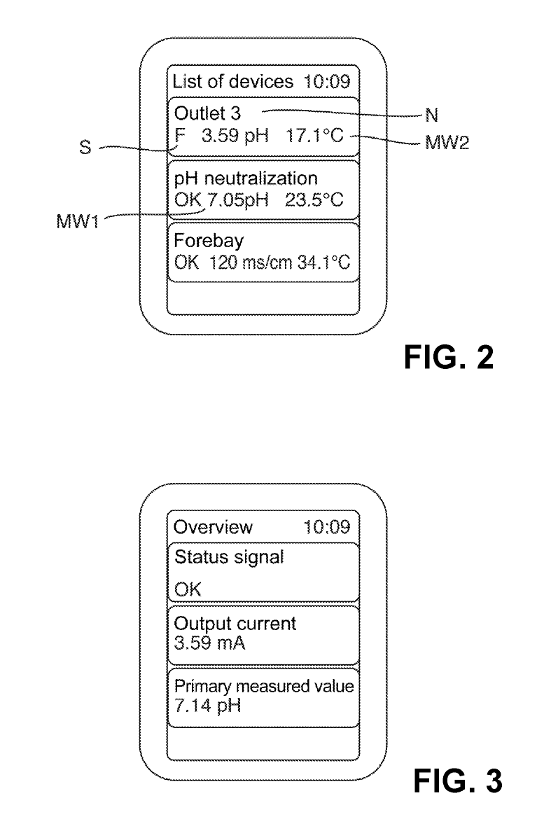

FIGS. 2-4 respectively show screenshots of a smartwatch SD.

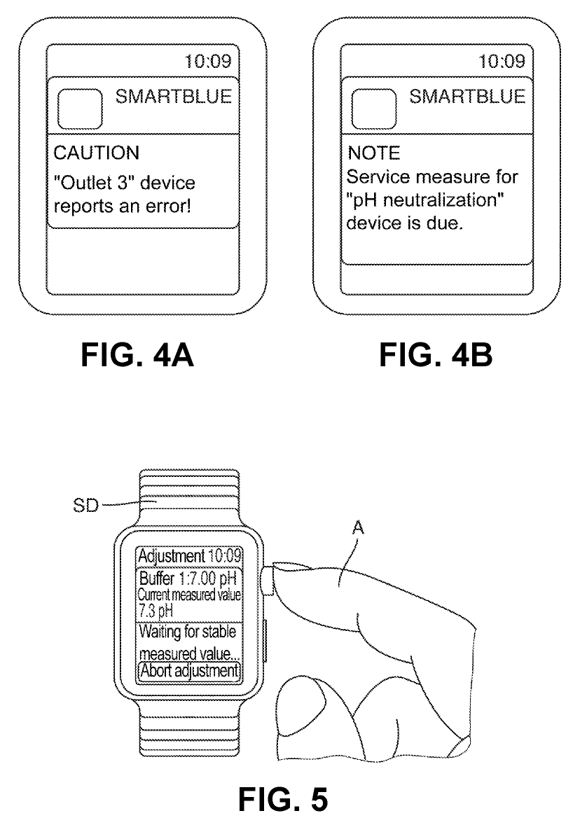

FIG. 2 shows a list of devices that are within range of the wireless connection 3. Shown here are the name N (also called device tag), status S, primary measured value MW1, such as pH or conductivity (unit: mS/cm), and the secondary measured value MW2 of all field devices FG. The status S can have different values, such as “F” for failure or “OK.” Where appropriate, the field device FG with an error message is highlighted with color on the display. Where appropriate, touching the touch surface of the smart device SD can switch to the next page with more field devices FG within range. The field devices in the example are called “Outlet 3,” “pH neutralization,” and “Forebay.” By a corresponding touch of these areas, more detailed information about the field device FG can be retrieved; see FIG. 3 or FIG. 4A. In this case, a point-to-point connection is established to the field device FG.

FIG. 3 shows more detailed information about the field device FG, such as status, output current, primary measured value, secondary measured value, next calibration time, etc. FIG. 3 shows the first page of this more detailed information of an individual field device. Where appropriate, the page must be “turned,” e.g., by swiping the display.

FIG. 4A shows an error message; FIG. 4B shows a note for an individual field device FG. The error message or the note can be displayed when the user A clicks on the respective area in the overview (see FIG. 2), or the error/note is automatically displayed when the user is within range of the radio connection 3. Alternatively, a small distance to the field device FG in the form of a location determination, e.g., by means of GPS, can be used as a trigger for displaying the error/note. Attention can be drawn to this message by appropriate acoustic or optical indications, or by vibration.

FIG. 5 shows a smartwatch during an adjustment process. Shown are the configured buffer, the current measured value, and the message that a stable measured value is awaited. Interaction of the user A to the effect that the adjustment process can be continued is awaited. This interaction takes place, for example, by pressing a key or by touching the touch surface of the smart device SD.

What is claimed is:

1. A method for maintaining a field device of process automation technology, comprising:
connecting a smart device to the field device via a data connection; and
maintaining the field device via the smart device.

2. The method according to claim 1, further comprising:
connecting the smart device to a smartphone, tablet, or phablet; and
connecting the smartphone, tablet, or phablet to the field device.

3. The method according to claim 1, further comprising:
connecting the smart device to a switching system or a cloud infrastructure; and
relaying the connection between the smart device and the switching system or the cloud infrastructure to the field device.

4. The method according to claim 1, further comprising:
outputting via the smart device a message when a service measure is due for the field device.

5. The method according to claim 1, further comprising:
showing operating steps of a service measure of the field device on the smart device.

6. The method according to claim 1, further comprising:
outputting via the smart device a list of field devices that can be connected within a wireless connection range of the smart device.

7. The method according to claim 2,
wherein the smart device, smartphone, tablet, or phablet includes a module for position determination, the method further comprising:
outputting via the smart device a message when a field device within a wireless connection range of the smart device does not establish a connection to the smart device.

8. The method according to claim 7, further comprising:
outputting via the smart device a message when a field device located within the wireless connection range of the smart device requires an action of the user.

9. The method according to claim 8, further comprising:
requiring a user to confirm the message; and
opening on the smart device an operating menu relating to the required action.

10. The method according to claim 1, further comprising:
showing via the smart device main properties of the field device after connecting the smart device to the field device.

11. The method according to claim 1, wherein the smart device is a smartwatch.

12. The method according to claim 1, wherein the smart device is a miniature computer worn on a head, having an optical display mounted on eyeglass frames in a periphery of a field of vision.

13. The method according to claim 12, wherein the smart device is integrated into safety glasses.

14. The method according to claim 12, further comprising:
showing via the optical display insets regarding the field device.

15. The method according to claim 12, further comprising:
acknowledging messages via user gestures or user voice control.

16. The method according to claim 12, wherein the smart device includes a camera, the method further comprising:
providing images from the camera to a remotely located service technician for remote maintenance.

17. The method according to claim 3, further comprising:
synchronizing a list of remaining and completed service measures between several service technicians via the switching system or the cloud infrastructure.
